(19) United States
(12) Patent Application Publication
(10) Pub. No.: US 2022/0198591 A1
(43) Pub. Date: Jun. 23, 2022

(54) Defense Property Management System

(71) Applicant: Muhammad Ikhlas, Willingboro, NJ (US)

(72) Inventor: Muhammad Ikhlas, Willingboro, NJ (US)

(21) Appl. No.: 17/556,226

(22) Filed: Dec. 20, 2021

Related U.S. Application Data
(60) Provisional application No. 63/127,771, filed on Dec. 18, 2020.

(51) Int. Cl. G06Q 50/18; G06Q 50/16; H04L 9/32

(52) U.S. Cl. CPC G06Q 50/18; H04L 2209/38; H04L 9/3239; G06Q 50/163

(57) ABSTRACT

The system and techniques disclosed include a software and/or hardware platform, including computer software applications (apps), a personal injury prevention projector (PIPP) and a backend system that can be used in the realm of property management. The system involves leveraging highly secure data storage mechanisms, such as Blockchain technology. The system can maintain an immutable record of property maintenance complaints and/or notices on the Blockchain to provide secure records (e.g., tamper proof, provides proof of receipt) that can be employed in mitigating fabrication and/or fraudulent claims relating to an owner's receipt (or non-receipt) of notice of a hazard which subsequently causes personal injuries, in order to support the defense of a property owner. The system automates property maintenance complaints and/or notices, recording them in a centralized storage location (e.g., Blockchain), which is usable as proof of receipt for the property owner and presented in a court in admissible form.

### RELATED APPLICATIONS

Under provisions of 35 U.S.C. § 119(e), the Applicant claims the benefit of U.S. provisional application No. 63/127,771, filed Dec. 18, 2020, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to a network-based system and method for creating and securely recording events associated with property management.

### BACKGROUND OF THE DISCLOSURE

Personal injury is a legal term for an injury to the body, mind or emotions of a person. The term is most commonly used to refer to a type of tort lawsuit in which the person bringing a lawsuit (e.g., plaintiff) has suffered harm to his or her body and/or mind. Personal injury lawsuits can be filed against the person or entity that caused the harm through, e.g., negligence, gross negligence, reckless conduct, or intentional misconduct, and in some cases, on the basis of strict liability. Different jurisdictions describe the damages (or the manner/means by which the injured person may be compensated) in different ways, but damages typically include the injured person's medical bills as well as compensation for pain and suffering and any diminished quality of life.

With respect to property management, a tenant in an apartment building (or rental home), for example, has certain statutory rights under local or state law (in addition to any number of additional rights pursuant to a written lease) to expect a certain level of safety and security in their premises and common areas, which can include protection from known hazards which could cause the tenant or his/her guests to suffer personal injury. For example, if a landlord had prior notice of a safety hazard on the given premises, or if the landlord has contributed to an environment on the grounds of the premises (e.g., an apartment building) that places a tenant/guest at risk for an accident or injury, the landlord may be held liable if a personal injury is sustained as a result of such known hazard or act of negligence. In such cases, the tenant may be able to pursue a personal injury lawsuit against the landlord or property owner for compensation. As a further example, if the landlord creates a potential hazard (mopping a floor and not placing any “Wet Floor” sign), no notice is necessary to establish liability, as the landlord “created” the hazard, so s/he was obviously on notice of it.

### BRIEF OVERVIEW

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are explanatory only and are not restrictive of the disclosure, as claimed.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an example of a communication system in which embodiments disclosed herein may be implemented for providing a property management system that generates a secure record as proof of receipt of maintenance complaints/notices, according to one or more embodiments shown and described herein.

FIG. 2 depicts an example of a message flow between a maintenance complaints/notices submitter (e.g., a tenant) and the Defensive Property Management System shown in FIG. 1, in accordance with an exemplary embodiment of the present disclosure.

FIG. 3 depicts an example of a computer system that may be used in implementing the Defensive Property Management System shown in FIG. 1, in accordance with an exemplary embodiment of the present disclosure.

FIG. 4 illustrates a flow diagram 400 of an example method for implementing aspects of the Defensive Property Management System (shown in FIG. 1) including but not limited to its functionality, in accordance with an exemplary embodiment of the present disclosure.

FIG. 5 depicts a block diagram of an example computer system 500 in which the disclosed aspects of the Defensive Property Management System (shown in FIG. 1), in accordance with an exemplary embodiment of the present disclosure.

### DETAILED DESCRIPTION OF THE DISCLOSURE

The present disclosure includes many aspects and features. Moreover, while many aspects and features relate to, and are described in, the context of facilitating the collection of secure, reliable proof (or showing an absence of proof—e.g., in the case where a tenant claims to have made a complaint but the DPMS data conclusively shows otherwise) of maintenance complaints and/or proof of the use of certain projected hazard warnings, all in the property management context, embodiments of the present disclosure are not limited to use only in this context. The present disclosure can be understood more readily by reference to the following detailed description of the disclosure and the Examples included therein.

Before the present articles, systems, apparatuses, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” mean that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed apparatuses, systems, and articles of the disclosure as well as the apparatuses themselves to be used within the methods disclosed herein. These and other materials are disclosed herein, and it is understood that when combinations, subsets, interactions, groups, etc. of these materials are disclosed that while specific reference of each various individual and collective combinations and permutations of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and apparatuses of the disclosure. Thus, if there are a variety of additional steps that can be performed it is understood that each of these additional steps can be performed with any specific aspect or combination of aspects of the methods of the disclosure.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

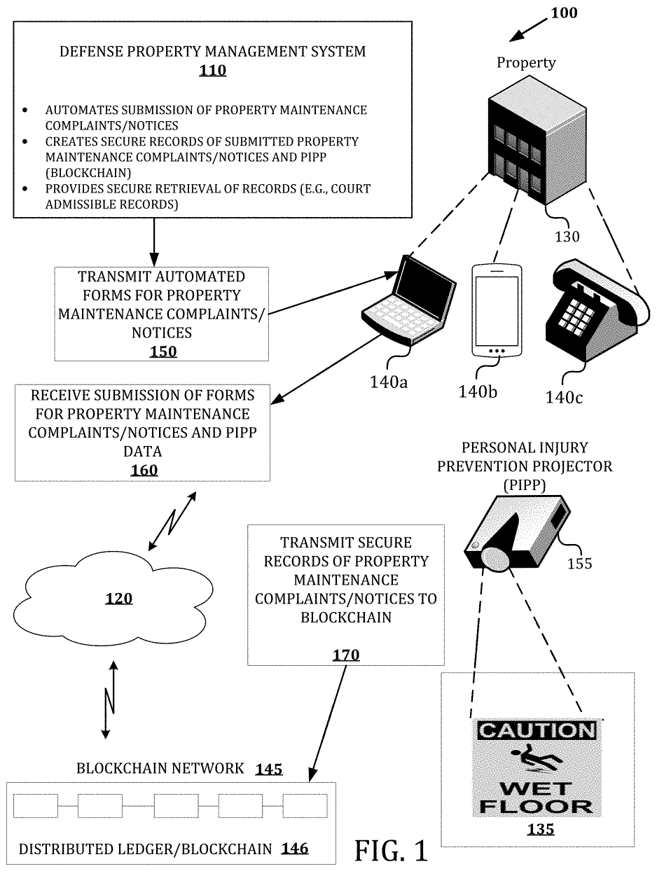

With reference now to the drawings, and in particular FIG. 1 through FIG. 5 thereof, examples of the Defensive Property Management System which may be configured to provide a communication system in which embodiments disclosed herein may be implemented for providing a property management system that generates a secure record as proof of receipt of maintenance complaints/notices, according to one or more embodiments shown and described herein. and the principles and concepts thereof will be described.

The system and techniques disclosed herein can be described as a software and/or hardware platform, including computer software applications (apps), a personal injury prevention projector (PIPP) and a backend system that can be used in the realm of property management. This system, and its components, can be referred to herein collectively as the Defensive Property Management System (or, at times, “DPMS”). As described herein, a key application of the Defensive Property Management System involves leveraging highly secure data storage mechanisms, such as Blockchain technology. As an example, the Defensive Property Management System can maintain an immutable (and court-admissible) record of property maintenance complaints and/or notices on the Blockchain to provide secure records (e.g., tamper proof, provides proof of receipt) that can be employed in mitigating fabrications and/or fraudulent claims relating to personal injuries in order to support the defense of a property owner. In other words, the Defensive Property Management System can automate property maintenance complaints and/or notices and subsequently record them in a centralized storage location (e.g., Blockchain), which can then be easily retrieved and used as proof of receipt or, more frequently, proof of the landlord/property owner's non-receipt of the complaint, which the property owner would present in a court of law to avoid liability for damages suffered due to a maintenance issue the landlord/owner never had notice of.

In an embodiment, the aforementioned Defensive Property Management System can include an image generation device, such as a projector, that can be particularly positioned to render characters and/or images onto a surface having a generally large area, such as a section of a floor in a building. As described herein, this image generation device can be referred to as a Personal Injury Prevention Projector (PIPP). As disclosed, the PIPP can display characters and/or images in a manner that is prominent against the projection surface (e.g., floor) and be easily visible to persons proximate to that area. Accordingly, PIPP generated characters and/or images can serve as a visible warning directly onto the surface that is deemed hazardous (e.g., wet, etc.) complete with a record of the warning projected and the duration of its projection, without the use of safety cones and physical signs (which can become a trip hazard themselves, and also offer no record of their having been used in a particular location and when), thereby helping to prevent accidents that may lead to bodily injury, and reducing the likelihood of a potential plaintiff prevailing at trial based upon false accusations of negligence (e.g., lack of proper warning of hazardous conditions).

Referring now to FIG. 1, an example of a communication environment 100 in which embodiments of the Defensive Property Management System 110, as disclosed herein may be implemented. The Defensive Property Management System 110 provides various features that add automation, secure recordation and access to data, such as property maintenance complaints and/or notices that are adequate to be used to discourage a tenant from resorting to oral notice to inform a property owner of a maintenance complaint, and to defend a property owner against false accusations and/or falsification of facts that may be pertinent in a personal injury lawsuit.

Often in scenarios involving bodily injury to a tenant on a landlord's property, specific evidence must be presented in a court of law that the landlord/property owner (or an employee/agent of landlord, etc.) was negligent in order to prove that a property owner is indeed liable for the personal injury of a tenant. In the case of a known hazard, the tenant ordinarily must show that the landlord had prior notice of the hazard in sufficient time for the landlord to have corrected it. For example, if a tenant slipped on their bathroom floor due to water from a pipe leak, the landlord may be held liable if the tenant told the landlord about the leak a sufficient amount of time before the alleged accident. Thus, it is common for tenants to falsely allege that they orally gave prior notice to the landlord via his/her agent (often the superintendent) so the plaintiff can establish liability. Often the only evidence the tenant presents is their own testimony, which often results in a costly battle of credibility (the superintendent will deny having received any oral notice of the maintenance concern, etc.) which, most often, can only be resolved at trial. This is why it may be desirable to provide a system that can be used in the realm of property management, utilizing electronic and/or recordable forms of communication for tenants to submit maintenance complaints (as opposed to oral/verbal communication) that can help mitigate the potential harm of plaintiffs who choose to fabricate allegations that they gave notice to the landlord of hazards relating to repairs/complaints on the property which may, in the end, be outcome-determinative in a personal injury lawsuit. With regard to the example of the landlord “creating” a hazard by, e.g., mopping a floor and failing to post adequate warning of the wet floor (our “Wet Floor” sign scenario above), the central issue may be whether or not the warning (wet floor sign, orange cones, etc.) was present. The Defensive Property Management System 110, as will be described in further detail below, in addition to storing dates and times of complaints and maintenance requests, can also provide projected warnings of common hazards and records of precisely when and where (i.e., each projection device is numbered on the system by location within the premises) the projection device was activated. The projection device projects the warning on the floor of the affected area without the need for warning cones and wet floor signs, which often become a trip hazard in and of themselves and provide no evidence (other than bare testimony) of their placement. Of course, the projection device can be sold separately (e.g., without the tenant submission/complaint notification feature of the defensive property management system) if an end user simply wants the projection device for its utility in eliminating the trip hazard cones and physical signs create, and its adjustable magnification capabilities to cover larger areas.

The Defensive Property Management System 110 can be a network-based platform (e.g., Internet) that may be accessed and interacted with by a plurality of distributed users, including an app on a smart device owned by a tenant. As shown in the illustrated example of FIG. 1, a plurality of devices 140a, 140b, 140c may be associated with a property 130 and capable of communicating with the Defensive Property Management System 110 via network 120 for example. In some instances, the plurality of devices 140a, 140b, 140c may be users that serve as a point of contact, perform the response and servicing, or are otherwise related to property maintenance complaints and/or notices. These types of users for the plurality of devices 140a, 140b, 140c can include, but are not limited to: tenant/occupants (most critically); maintenance professionals; property managers; employees of the property owner; and the like.

Also, examples of devices 140a, 140b, 140c are shown to indicate the various mechanisms that can be employed to interact with the Defensive Property Management System 110. For instance, device 140a is shown as a laptop computer which can be used to receive and/or submit data in communication with the Defensive Property Management System 110, such as a maintenance complaint by a tenant and/or notice in the form of an automated form and/or an electronic message, such as an e-mail. A device 140b is shown a portable cellphone device, particularly as a smartphone, which can download a mobile application (app) that is designed to electronically submit maintenance complaint and/or notice in communication with the Defensive Property Management System 110.

Furthermore, a device 140c is shown as a land-line telephone which, for persons who lack computer savvy or lack a smart phone and/or computer entirely, can be used to submit a maintenance complaint and/or notice via a dial-in communication with the Defensive Property Management System 110. Importantly, reporting via any of the stated devices/methods, creates an indelible record in the system (via any reliable means, e.g., analysis of metadata; blockchain, etc.).

As an example of the laptop device 140a interacting with the Defensive Property Management System 110, the system 110 can generate automated forms that are to be used by designated property management personnel, when responding to any property maintenance complaints and/or notices that have been reported by a tenant/occupant on the property 110. These automated forms can be accessed (e.g., from a property management website) by the user of the laptop computer 140a, and can include data fields that the user then fills-in with information related to a maintenance complaint and/or notice. The automated form can be particularly designed to capture information surrounding the maintenance complaint and/or notice that may be deemed pertinent in a personal injury lawsuit and could be admissible in a court of law to defend the property owner against falsehood, misinformation, false accusations, or purported negligence. As an example, a maintenance professional can populate fields on an automated form generated by the Defensive Property Management System 110 using a tablet or laptop 140 while they are physically present at a unit on the property 130 to inspect a maintenance issue, for instance a leaking faucet, that has been reported by a tenant. The Defensive Property Management System 110 will record identifying and factual information related to user and the maintenance complaint, such as the user's Internet Protocol (IP) address and Global Positioning System (GPS) location at the time of login, which may also be of use to prove responsiveness by the landlord/owner.

The automated form can be displayed on a laptop computer device 140a allowing the user to directly enter important information relating to the maintenance complaint and/or notice, such as: date; time; location; description of issue; name of the responding property personnel; and whether the issue was resolved. Pictures can be added as well, with time/date stamps embedded therein. Accordingly, by filling-out the automated form (and submitting that automated form to the Defensive Property Management System 110) the system 110 can generate an electronic record corresponding to this automated form (including the information entered in the form's data field) and the associated maintenance complaint and/or notice. In some cases, the Defensive Property Management System 110 can add additional information, such as metadata, to an automated form, such as a timestamp, indicating when that automated form was successfully received by the system 110. Therefore, in response to receiving the submission of the automated forms by the laptop computer device 140a, the Defensive Property Management System 110 can create a storable record that reflects facts (e.g., date, time, etc.) surrounding the property maintenance complaints and/or notices, and further indicates whether property management was made aware of (and in some cases resolved) the maintenance issue. Consequently, the Defensive Property Management System 110 automates property maintenance complaints/notices in a manner that can: 1) eliminate the need for a tenant to rely on orally alerting a maintenance professional, for example, of a property maintenance complaint; and 2) eliminate the need for these types of property management issues to be recorded and assembled manually using physical records (e.g., paper journals). Over time, handling vast amounts of information relating to property management can be cumbersome, more prone to mishandling (e.g., loss, inaccuracy, or susceptibility to tampering) when manually compiled, which is only exacerbated if a property management portfolio continues to grow to include more properties. By the Defensive Property Management System 110 having the capability to automate the collection of these property maintenance complaints and/or notices in an electronic form, and to store these records in a secure and centralized mechanism, such as a Blockchain, this information is in better condition (as compared to manual records or conventional property management system records) to be accessed and presented in a court of law to conclusively resolve the common issue (in personal injury cases) as to whether the property owner had (prior) notice of an issue, namely the recorded notice/property maintenance complaint which a plaintiff may cite as the cause of their accident or injury.

In some embodiments, the Defensive Property Management System 110 is configured with rules and/or specifications that determine which information is deemed pertinent to a personal injury lawsuit or can be used to defend the property owner from unfounded negligence claims. As an example, the Defensive Property Management System 110 can be configured to create records in a form that takes into account the below realities and facilitates the use of the very best property maintenance practices:

1) If an accident occurs there is often no liability unless there is proper notice given, especially for residential properties;
2) For tenants to give notice of defects, the notice must be given to the landlord/owner or his/her agent. Once that notice has been given and sufficient time to correct has elapsed, the liability for any resulting injury will henceforth fall upon the landlord;
3) Property management creates a data record of reported complaints, thereby acknowledging an issue exists; and
4) Complaints should be escalated until action is taken (e.g., escalation can be automated and built into the system to the point that, if not resolved in sufficient time, the owner of the property him/herself will be called on his/her personal cell phone and emailed on his/her email about the missing light bulb, etc.)

Similarly, the laptop computer device 140a can be used to submit an electronic message, such as an e-mail, to the Defensive Property Management System 110 that includes the information related to a property maintenance complaint and/or notice as described in detail above. In this embodiment, the Defensive Property Management System 110 may not be required to communicate pre-defined prompts, such as an automated form, thus allowing the user more flexibility in entering information surrounding the property maintenance complaints and/or notices. For example, a tenant may call property management in order to report a maintenance issue (we note, this is the least preferred method of reporting a complaint, as it is the most susceptible to human mishandling on the owner/landlord's end). The Defensive Property Management System 110—whether or not an operator answers or a message is left—records every second of the call and stores it in unchangeable form. For instance, the Defensive Property Management System 110 will record the call initiated by the tenant in its entirety, and log additional data related to the call, such as the telephone number associated with the incoming call. In response, a maintenance professional may be dispatched to the particular unit on the property 130 and can use the laptop computer 140a to draft an e-mail including information related to the maintenance complaint and/or notice. In some cases, the laptop 140a may be used by the tenant to create an e-mail that is transmitted to the system 110 to submit their property maintenance complaint and/or notice, which further dissuades the tenant from giving oral notice. Similar to the automated forms alluded to above, an e-mail can include information surrounding the maintenance complaint and/or notice that may be deemed pertinent in a personal injury lawsuit or admissible in a court of law to defend the property owner against falsehoods, misinformation, false accusations, or purported negligence. In contrast, employing a user-generated e-mail (as opposed to system-generated automated forms) may be more suitable in scenarios where the property management personnel has been trained to ascertain the known pertinent information (e.g., time, date, location, etc.) and may have the experience to assess the surrounding environment in the unit to ascertain tangential information that may otherwise not be prompted by data fields on a form (e.g., water stain left on floor indicating prolonged time of leak). Thus, by submitting a user-generated message, greater amounts of information that may be deemed important if the property owner needs to defend themselves in a personal injury lawsuit in the future, due to this issue, may be captured by the Defensive Property Management System 110. In this embodiment, the user-generated e-mail may be sent by the laptop computer 110 to an e-mail address corresponding to the Defensive Property Management System 110. In response to submitting the property maintenance complaints and/or notices as an e-mail, the Defensive Property Management System 110 can generate a record using the contents of the e-mail in their entirety or, using its text extraction mechanisms, parse the contents of the e-mail and create a record using only certain portions of the e-mail.

Further, a device 140b is shown in FIG. 1 as a smartphone, cell phone, tablet or other mobile device. In this case, the user (most commonly a tenant/occupant) may employ their smartphone 140b to access a mobile app that is supported by the Defensive Property Management System 110 and particularly designed for use on mobile devices. An app can be downloaded for the Defensive Property Management System 110 by the smartphone 140b prior to its use. Also, the app can be used to capture the property maintenance complaints and/or notices using user-generated and/or system-generated mechanisms as previously described. As an example, a maintenance professional that is physically present in a unit on the property 130 (in response to a tenant having made a complaint via the app or calling directly to report a maintenance issue in their apartment) can use their smartphone 140b to access an app that allows them to submit data collected while responding to the tenant's complaint, which may have been submitted in an electronic form. Electronic forms can include e-mails, as described above, or other forms that are conventionally associated with smartphones, such as text messages (text extraction technology will instantly prompt the submitter of a deficient submission to add all pertinent information, e.g., address/unit/submitter or lease holding tenant's name), Multimedia Messaging Service (MMS) messages (including texts and images), and the like. According to the embodiments, the app can utilize network 120 to communicate with the system 110, including submitting the property maintenance complaints and/or notices. In some embodiments, the smartphone 140b can be used to submit the property maintenance complaints and/or notices via a dial-in mechanism, as described in detail below in reference to device 140c. Additionally, the smartphone 140b may be used by the tenant (having the associated app downloaded thereon) in order to submit the property maintenance complaints and/or notices to the system 110, and thereby providing yet another electronic alternative to speaking with property management/maintenance personnel to notify them of the property maintenance complaint/issue.

Additionally, a device 140c is shown in FIG. 1 as a land-line telephone. In this case, the user may employ a telephone 140b to call, or establish a dial-in connection with the Defensive Property Management System 110 in order to submit a property maintenance complaint and/or notice. As an example, if a tenant calls a property manager (e.g., at the leasing office) to report a maintenance issue, the property manager can: 1) give the caller the direct number into the DPMS, 2) divert the caller to the DPMS 110. The call will then be recorded, and the caller will be guided step by step through an automated call (including multiple pre-defined voice prompts). By dialing into the Defensive Property Management System 110, the caller/tenant can describe the maintenance complaint and/or hazard directly, which ensures that an electronic record is created by the system 110. For instance, the Defensive Property Management System 110 can have an associated toll-free telephone number (1-800 number) that can be dialed by the land-line telephone 140c in order to access the voice capabilities of the system 110 (this is the number that will be given to the calling tenant by the operator before attempting to transfer the caller directly to the Defensive Property Management System.

Thus, more traditional forms of contact, such as dial-in using a land-line telephone 140c, can be leveraged by the Defensive Property Management System 110 to alleviate any complaints by the non-computer savvy or those occupants/tenants without computers or smartphones, in order to document the specific maintenance issue. The recording of the call and the multi-language-capable prompt-based system can ensure retrieval of all pertinent data and make sure no one can falsely claim they provided oral notice of a complaint to the management office (also, the tenant will have credibility hurdles trying to explain to a jury why they did not/could not use other, more reliable and convenient means of reporting the concern). Accordingly, the land-line telephone 140c can use telephone-based networks, such as Public Switched Telephone Network (PSTN), Plain Old Telephone Network (POTN), or Integrated Services Digital Network (ISDN) to establish a dial-in connection and support voice calls with the Defensive Property Management System 110. To enable the aforementioned dial-in features, the Defensive Property Management System 110 can include automated phone or interactive voice response capabilities which enable a telephone-based portion of the system 110 to provide automated interaction with the callers (e.g., without input from a human other than the caller him/herself). For example, the Defensive Property Management System 110 can utilize interactive voice response (IVR) technology to automate the telephone contact between humans and machines that can convert the voice data from the caller, conveying the pertinent information related to the maintenance issue, into an electronic record of the property maintenance complaints and/or notices that can be further securely maintained and accessed by the system 100. As alluded to above, the system 110 can record a tenant's call regarding the property maintenance complaint in its entirety, as well as logging additional information that is related to the call (e.g., phone number where the call originated). Although the dial-in aspects are described in reference to land-line phone 140c, it should be appreciated that other devices having voice, telephonic, or Voice over Internet Protocol (VoIP) capabilities, such as smartphone 140b and laptop computer 140a (VoIP) can be used to submit the property maintenance complaints and/or notices via a dial-in mechanism, as described above.

The communication network 120 can support any number of wireless communication protocols such as: WIFI, BLUETOOTH, ZIGBEE, cellular based protocols, etc. In some implementations, the communication network 120 may comprise a wired link. It should be appreciated that the user devices 140a, 140b, 140c may be implemented as various numbers of computing devices, such as a smartphone, a tablet, a laptop, a workstation, a local or remote server, or a wearable device such as a smartwatch. Not shown in FIG. 1 are networks that can be used to support dial-in telephone services such as PSTN, POTN, and ISDN.

The Defensive Property Management System 110 can be a backend computer system(s), such as a server, implementing the functionality and features that support automated property maintenance complaints and/or notices, creation of electronic records, and the secure storage and accessibility of those electronic records from a centralized storage mechanism (e.g., Blockchain) to be used as proof of receipt (or, more frequently, non-receipt) for the landlord in a court of law. For example, the Defensive Property Management System 110 can be a server computer that can be configured to: automate submission of property maintenance complaints and/or notices that ultimately may be relevant in personal injury lawsuits (via automated forms, electronic messages, mobile apps, or dial-in mechanisms); create secure records of submitted property maintenance complaints and/or notices and data collected from the Personal Injury Prevention Projector (PIPP) on the Blockchain as proof of a property owner's receipt of notice of a maintenance problem; and provide secure retrieval of the records stored and/or maintained on the Blockchain, for example to be used as court-admissible evidence to mitigate fabrication and/or fraud by the tenant in a personal injury lawsuit relating to the maintenance complaint.

A key feature of the Defensive Property Management System 110 is storing the electronic records of property maintenance complaints and/or notices that were submitted to the system 110 into a secure storage mechanism. In the illustrated example of FIG. 1, the Defensive Property Management System 110 further communicates the records to a Blockchain. By utilizing Blockchain (or similar “indelible” method), the Defensive Property Management System 110 can leverage features that are specific to distributed ledger technology to create tamper-proof, immutable versions of the maintenance complaint records on the Blockchain, and thereby enhancing the security and reliability of these records over more conventional storage mechanisms (e.g., databases).

FIG. 1 illustrates that the Defensive Property Management System 110 is communicatively connected to a Blockchain network 145. As illustrated, the Blockchain network 145 can include a distributed ledger 146, also referred to herein as the Blockchain. As used herein, the term “distributed ledger” may refer to a shared digital ledger that is decentralized and can be synchronized among nodes distributed across the Blockchain network 145. In some embodiments, a transaction is approved to be written or stored to the distributed ledger 146 after the transaction is consented to by at least the majority of the participating nodes on the Blockchain network 145. The contents of the distributed ledger 146 can be synchronized across all the participating nodes on the Blockchain network 145. Different types of consensus mechanisms may be implemented on the participating nodes to bring in varying levels of processing requirements to achieve agreement amongst the participating nodes. Examples of common consensus mechanisms may include, but are not limited to, proof of work, proof of stake, proof of elapsed time, Kafka distributed streaming platform, etc. In some examples, when a new participating node is added to the Blockchain network 145, a copy of the distributed ledger 146 may be downloaded to the newly joined participating node.

In the distributed ledger 146, data is generally stored as a Blockchain of chronologically ordered, back-linked list of data blocks. A number of data blocks in the Blockchain are connected together via use of hashing. For example, when a new block is added to the Blockchain, the new block includes a hash reference such as a hash of a predecessor block. In this manner, several data blocks may be chained together to form a Blockchain and each additional block creates an additional immutable record, which collectively provide security for and validation of the entire Blockchain. This makes it difficult to retroactively alter data stored within the Blockchain without that alteration being detected. A Blockchain may also include information about the participating nodes, an owner of a block and content of the block right from the first block to the most recently completed block (also referred to as a latest data block). Accordingly, once the Defensive Property Management System 110 transmits a record to be added as a block on the Blockchain 146, that record is inherently tamper-proof and immutable. In comparison, if the maintenance complaint was entered into a conventional Excel™ spreadsheet or a database table, (both made up of rows and columns) the landlord/owner's records would still be vulnerable to a credibility attack by way of an allegation of fabrication or, more critically, deletion of a complaint. Adept plaintiffs' counsel will argue that the landlord/owner was free to add more rows, add new columns, edit existing rows, and delete entire columns, altering the records in a manner so as to create an advantage in litigation. By creating a Blockchain 146 of maintenance records, the Defensive Property Management System 110 brings a level of integrity to the records and stores records in a secure and reliable environment for use as proof of receipt and factual data for either party (most frequently the landlord/owner) to be presented in a court of law. In some embodiments, the Defensive Property Management System 110 may be configured to employ additional security mechanisms, such as user authentication and/or authorization. For example, a property owner may be the only user authorized to access the Blockchain 146 to retrieve any records stored thereon. Thus, the Defensive Property Management System 110 may require user credentials to be provided by a user and successfully verified prior to allowing the retrieval of a record of a property maintenance complaint and/or notice.

Also, each block in the Blockchain 146 can contain a header, which includes metadata about that particular block. Even further, to identify a block, a unique cryptographic hash which corresponds to a particular block can be created by hashing that block's header (e.g., hashing the header twice with the SHA256 algorithm). Accordingly, this unique hash can be used as a block identifier for each block in the Blockchain 146. In an embodiment, the Defensive Property Management System 110 can save a correlation between a particular property maintenance complaint and/or notice and the block identifier of the block that stores the record of the maintenance complaint and/or notice therein. Subsequently, this same correspondence can be used by the Defensive Property Management System 110 to access a particular block on the Blockchain 146 and retrieve the record of the complaint and/or notice that is stored in that block. It should be understood that using block identifiers to access stored property complaints and/or notices on the Blockchain 146 are described merely as an example, and other mechanisms may be employed such that records can then be easily retrieved and used as proof of receipt/non-receipt by either party in a court of law. Similarly, it should be appreciated that the embodiments are not limited to Blockchain technology and distributed ledger technology (DLT), therefore other forms of secure storage mechanisms may be employed to store and maintain the records of a property complaint and/or notice as deemed necessary or appropriate.

In addition, FIG. 1 shows a PIPP 155 can be placed on the property 130 and communicatively connected to the Defensive Property Management System 110. Generally, the PIPP 155 can be described as an image generation device that can be particularly positioned to display light, colors, characters, and images to serve as visible warnings directly onto a surface that is deemed hazardous (e.g., wet, under construction, etc.). As shown in FIG. 1, the PIPP can be implemented as a projector, that emits light to project an image, including text, onto a large or small section of the floor on the property. Furthermore, the PIPP 155 may be focused, or otherwise adjusted to display images that cover a range of areas. Accordingly, the PIPP 155 can be adjusted to generate a visible warning that covers a small target area, such as a missing tile on a floor; or a larger area, such as an entire lobby floor that may be wet from rain outside being tracked inside at a building's entrance. The PIPP 155 may be an improvement over commonly used hazard indicators, such as cones, or small signs, which: a) typically cover only a small portion of an area that is deemed hazardous; b) can be a trip hazard themselves; c) whether or not said hazard indicators were in place, where, and at what specific times is typically unpreserved. The PIPP 155, through communication with the Defensive Property Management System, creates a record of exactly when it was illuminated, for what duration, what level of magnification (i.e., how large of an area it covered) and which PIPP 155 device(s) was illuminated (each would be identified by location and would be illuminated to cover a set area of responsibility). Further, the PIPP 155 is a further improvement for coverage reasons, for example, if hazard cones are placed at certain points on a wet floor, the potential still remains for a person to step onto a section of the floor where a hazard cone is not placed. Thus, with a hazard cone not within this person's line of sight, this person may still be completely unaware that they are stepping onto a slippery floor, which can lead to personal injury due to fall and accusations of negligence against the property owner. In contrast, the PIPP 155 can be strategically placed and adjusted such that the, e.g., visible “WET FLOOR” image can completely cover the entire hazardous area. As a result, there is often no assumable section of a hazardous area where the warning is not visible to a person proximately located, using the PIPP 155. Therefore, the PIPP 155 has the potential to mitigate accidents that may lead to bodily injury and accusations of negligence (e.g., improper/missing warning of hazardous conditions). In other embodiments, the PIPP 155 can emit light in various colors, in the form of a laser, which illuminates the hazardous area (e.g., area needing repair, wet floor). For example, the PIPP 155 can shine a bright laser, or LED light over a stencil, onto the floor, in a color which is prominent against the floor's surface to easily capture the attention of a person entering the hazardous area. Also, in some embodiments, the PIPP 155 may include an audio output, such as a loudspeaker, which can be used to produce audible warnings, such as a vocal announcement concerning the condition of the area.

The PIPP 155 can be particularly structured to be lightweight, to have low-power consumption (or having its own power source), and for easy retrofitting onto ceiling structures within a building. For instance, the PIPP 155 may include fastening mechanisms, such as clips or screws, which allow the projector to be fixedly attached to most types of commercial lighting structures. Furthermore, a key aspect of the PIPP 155 is that it can communicate with the Defensive Property Management System 110. For instance, the PIPP 155 may be implemented with Internet of Things (IoT) capabilities that allow the PIPP 155 to passively transmit raw data, such as time stamps, and status identifiers (e.g., on/off) to the Defensive Property Management System 110. Consequently, the Defensive Property Management System 110 can create a record relating to the PIPP 155, e.g., indicating when the device was on, which may be used to refute claims of negligence due to a lack of hazard indicators if a person suffers injury as a result of a slip-and-fall on the property 130.

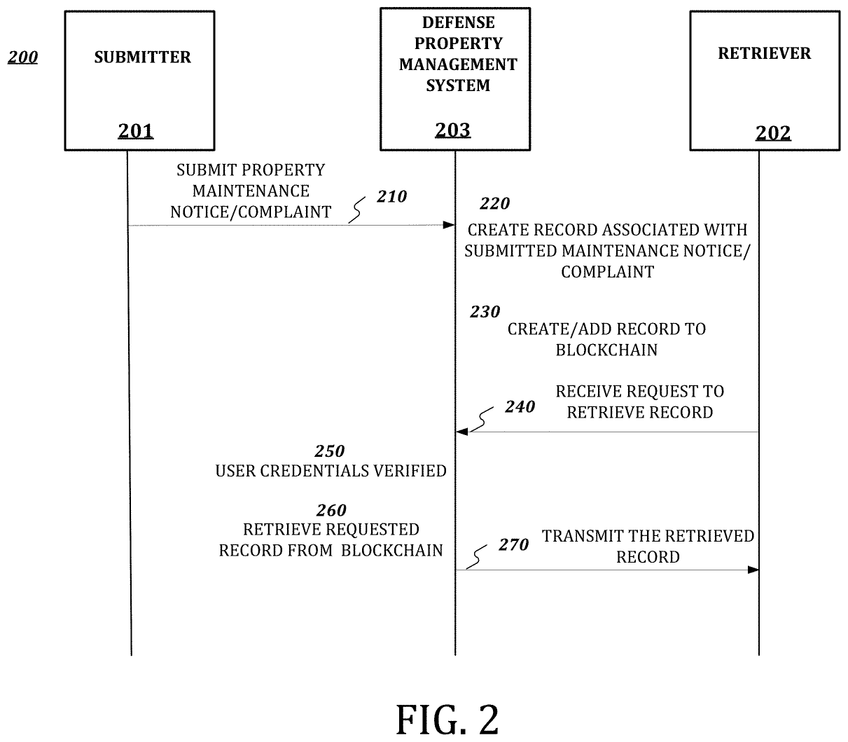

Referring now to FIG. 2, an example of a message flow 200 between a device associated with a property maintenance complaint and/or notice submitter 201 (e.g., tenant or even property management personnel), a device associated with a property maintenance complaint and/or notice retriever 202 (e.g., property owner), and the Defensive Property Management System 203 is shown. The message flow 200 can be related to the automated collection of a property complaint and generate a secure record of this property complaint that can ultimately be retrieved, in accordance with an exemplary embodiment of the present disclosure. Initially, a submitter's device 201, such as smartphone used by a tenant or maintenance professional, can be employed to submit a property complaint and/or notice to the Defensive Property Management System 203 at flow 210. According to the embodiments, the submitter's device 201 can transmit the property complaint and/or notice using various means, including e-mail, dial-in, mobile app, or an automated form. The transmission means may be based on various factors, such as the type of device being employed as the submitter's device 201. For instance, if the submitter's device 201 is a land-line phone, flow 210 may involve establishing a dial-in connection with the Defensive Property Management System 203 to submit a property complaint and/or notice using the IVR features of the system 203. As another example, if the submitter's device 201 is a laptop computer, flow 210 can involve establishing an Internet (or WAN) connection with the Defensive Property Management System 203, which allows the property complaint and/or notice to be submitted to the system 203. After the Defensive Property Management System 203 has successfully received the property complaint and/or notice, the system 203 can then generate an electronic record using the data from the submitted property complaint at operation 220. In some cases, operation 220 can involve the Defensive Property Management System 203 extracting particular data from the received property complaint and/or notice that is deemed pertinent to a personal injury lawsuit. For example, the Defensive Property Management System 203 is configured with rules (or specifications) that govern which information is to be included in the record of the property complaint and/or notice, such as whether the complaint was escalated, and the date of the complaint. Accordingly, at operation 220, the Defensive Property Management System 203 automatically generates an electronic record of a property management complaint, the absence of which can serve as a reliable, court-admissible indication that the tenant/occupant did not provide the property owner with notice of a maintenance issue on the property. Also, in more nuance cases, the tenant's lack of specificity of the issue can also defeat a personal injury suit when the tenant gives notice of a complaint that is not the same as the issue which caused the injury. Depending on the jurisdiction and statutory/case law developments in those locales, this may further aid in the property owner's defense. The Defensive Property Management System 203 provides a centralized and automated solution for collecting data that can prove whether the property owner had (prior) notice of an issue which a plaintiff may cite as the cause of their accident/injury. Even further, the Defensive Property Management System 110 provides the various electronic-based means for a tenant to submit a property maintenance complaint and/or notice, including e-mail, dial-in, mobile app, etc., to deter tenants from resorting to oral complaints, which are more susceptible to falsification and are difficult to prove or disprove in any potential litigation involving the complaint.

This capability of the Defensive Property Management System 203 is an improvement over methods that are currently employed by some existing property management systems, where proof of notices may be manually assembled from a plurality of different sources. Even if the proof of notices are assembled after a cumbersome and labor-intensive manual process (e.g., reviewing manual maintenance journals, reviewing call logs), many of these notices may be insufficient as evidence to conclusively defend the property owner in a court of law because of, e.g., their susceptibility to tampering/augmentation by the landlord. For instance, a phone record showing that a tenant called about a maintenance concern does not prove that a specific maintenance problem was discussed. Even further, conventional property management systems may collect all types of information, making it more difficult to determine which data is pertinent to a specific personal injury lawsuit or corresponds to a specific maintenance issue. For example, landlords currently may have only one phone line for all matters—from rent to recycle collection. In contrast, the Defensive Property Management System 203 can have a designated phone number for dial-in, thereby receiving calls that are specifically related to property maintenance complaints and/or notices (e.g., maintenance calls made to the leasing office will be redirected/transferred). By way of the Defensive Property Management System's 203 centralized integration of multiple means of notification using automated and electronic means, the system 203 increases ease of use for tenants to report issues, while simultaneously significantly reducing the possibility of fabrication and/or fraud by tenant/plaintiff (or even the owner). Records generated by the Defensive Property Management System 203 at operation 220 can replace handwritten (and corruptible) logbooks and obviate the need to subpoena phone records from outside (non-integrated) providers as proof, etc.

Next, at operation 230, the Defensive Property Management System 203 can take the record of the property maintenance complaint and/or notice and create a new Blockchain or add a block to an existing Blockchain of previously created records. In other words, contents of the record are stored within a block of the Blockchain structure. Due to the features of Blockchain technology, once the record is stored in the Blockchain, an immutable and tamper-proof version of the record is created which enhances the security of the system. In some embodiments, operation 230 can involve the Defensive Property Management System 203 communicating with a Blockchain network that includes the Blockchain and creating a unique Blockchain identifier that particularly corresponds to the added block on the Blockchain.

At some point, the Defensive Property Management System 203 can receive a request to retrieve a record of a property maintenance complaint and/or notice from a retriever's device 202 in flow 240. For example, the retriever can be the property owner, or an authorized agent of the property owner, such as an attorney. As an example, the property owner can be made aware of a personal injury suffered by a tenant that has occurred on the property and may want to access the Defensive Property Management System 203 to retrieve any records of maintenance issues related to this tenant that may be stored on the system 203. In some embodiments, the property owner must submit credentials using a retriever's device 202, such as a laptop computer. For example, in response to receiving the initial request from the retriever's device 202, the Defensive Property Management System 203 can transmit a query to the property owner for them to submit their credentials (e.g., username, password), and subsequently verifies the provided credentials prior to retrieving records at operation 250. Accordingly, the Defensive Property Management System 203 provides an extra layer of security, ensuring that records are only retrieved by authorized users.

Subsequently, the Defensive Property Management System 203 can access the Blockchain in order to retrieve the requested records at operation 260. In some embodiments, the Defensive Property Management System 203 maintains a correspondence between specific blocks on the Blockchain and particular property maintenance complaints and/or notices. For example, the Defensive Property Management System 203 may be able to identify one or more property maintenance complaints and/or notices that correspond to a particular tenant. The Defensive Property Management System 203 can then determine the corresponding block identifier for each complaint record that has been stored on the Blockchain for that tenant. The block identifiers can be used to access those specific blocks on the Blockchain, in order for the system 203 to retrieve the contents of the secure record. At flow 270, the Defensive Property Management System 203 can transmit the successfully retrieved record to the retriever's device 202. For example, the system 203 can transmit a form including the contents of the record that was retrieved from the Blockchain to be displayed on the property owner's laptop computer. By reviewing the retrieved record, a property owner can determine whether the associated property maintenance complaint and/or notice is, in fact, proof of the property owner's receipt (or proof of non-receipt when a plaintiff is fabricating tales of alleged notice) of notice of a particular maintenance problem.

In at least some exemplary embodiments of the present disclosure, the Defensive Property Management System 203 may further provide a secured database may be stored in the blockchain such that each entry and data record is tamper-proof, fortified, shielded from tampering, safeguarded from being altered, and ensconced in an impregnable blockchain ledger. Each record or log entry may be stored as a separate transaction or data entry in the blockchain. The record or log entry transaction may also serve as a maintenance record incident report, service request, resolution notification, safety notice, public notification of ongoing maintenance, or other associated log entry transaction. In at least one instance, the record or log entry may be published to the blockchain by a server, controller, computer and/or by one or more modules of the Defensive Property Management System so that, for example, neither party can censor the log entry; and/or there can be a public property registry of all records, log entries and notifications; and/or there may be a monthly maintenance report that lists maintenance reports, outstanding service requests, completed service requests, and other entries. In one or more examples, the entire secured database as a chunk of data may be stored in the blockchain as a single transaction or data entry. In still further embodiments, the secured database may be published to the DPMS blockchain less often than each time a block is created. Any suitable technique may be used to format and record the database on the blockchain. The exemplary embodiments disclosed herein may be used with any appropriate formats and/or recordation methods.

In one or more embodiments of the present disclosure, the Defensive Property Management System 203 may be configured to use advanced methods to ensure only log entries and records verified by the DPMS methodology are counted and recorded. In accordance with these embodiments, log entries or records that are considered to be verified may be added to a publicly accessible database containing anonymized data regarding the log entries or records. In alternative embodiments, the system may be configured with open-source tools to ensure the transparency and accountability of the system. With these tools, property owners, property managers, residents, other users and necessary third parties (including but not limited to tenant associations, legal aid committees, neighborhood boards, community review boards, citizen watch organizations, nonprofits, municipal, county, state, federal government agencies, agents, representatives, legal representatives, attorneys, and others) are able to review the data to ensure its accuracy and credibility. Although the view data may be anonymous, individual users can generate their own unique ID to verify that the log entries or records recorded for their ID are accurate and not manipulated. In accordance with these embodiments, to ensure that the data stored within the publicly accessible secured DPMS database is reflective of the true actual data, some or substantially all records and log entry data may be sent both to a verifying system (which may include one or more verification modules performing the verification methods included in this present disclosure and other known blockchain and cryptography verification method) as well as to the servers hosting the data content (servers may be include but not be limited to private, public, and/or third party servers). This allows the Defensive Property Management System 203 to automatically check that the data on the servers' secured database is accurate and has not been altered. In at least one instance of the present disclosure, the Defensive Property Management System 203 further comprises one or more modules and/or applications that automatically checks that the log entries or records on the blockchain are verified and matches the log entries or records on the public database. If there is any corruption or change to the data detected, an alert notice may be automatically provided by the Defensive Property Management System 203. In this manner, the Defensive Property Management System 203 prevents various methods that users (i.e. tenants, maintenance staff, others, etc.) may attempt to manipulate.

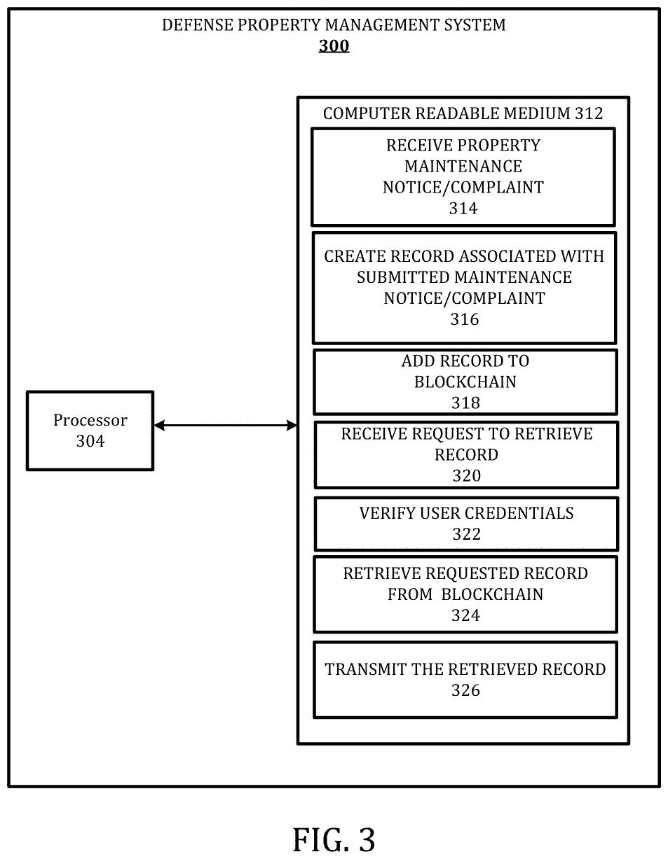

FIG. 3 illustrates an example of a computing device 300 that can be employed for implementing the defense property management system, as described herein. For example, the defense property management system 300 may be a computing device or a server computer, or the like, and may include a processor 304, which may be a semiconductor-based microprocessor, a central processing unit (CPU), an application specific integrated circuit (ASIC), a field-programmable gate array (FPGA), and/or another hardware device. Although a single processor 304 is depicted, it should be understood that the defense property management system 300 may include multiple processors, multiple cores, or the like, without departing from the scope of the system.

The defense property management system 300 may include a non-transitory computer readable medium 312 that may have stored thereon machine-readable instructions executable by the processor 304. Examples of the machine-readable instructions are shown as 314-326 and are further discussed below. Examples of the non-transitory computer readable medium 312 may include an electronic, magnetic, optical, or other physical storage device that contains or stores executable instructions. For example, the non-transitory computer readable medium 312 may be a Random-Access memory (RAM), an Electrically Erasable Programmable Read-Only Memory (EEPROM), a hard disk, an optical disc, or other type of storage device.

The processor 304 may fetch, decode, and execute the machine-readable instructions 314 to receive a property maintenance complaint and/or notice. For instance, a submitter can use a device, such as a laptop computer, smartphone, or landline telephone to communicate the property maintenance complaint and/or notice to the defense property management system 300. The maintenance complaint and/or notice may be communicated using various means, including e-mail, dial-in, mobile app, or an automated form. The transmission means may be based on various factors, such as the type of device being employed as the submitter's device. The defense property management system 300 may receive the property maintenance complaint and/or notice by various means, including: establishing a dial-in connection using the IVR features; establishing an Internet (or WAN) connection; and establishing a connection via a mobile app.

The processor 304 may fetch, decode, and execute the machine-readable instructions 316 to create an electronic record using the data from the submitted property complaint. Thus, the Defensive Property Management System 300 automatically generates an electronic record of a property management complaint, the absence of which can serve as a reliable, court-admissible indication that the tenant/occupant did not provide the property owner with notice of a maintenance issue on the property. Records generated by the Defensive Property Management System 300 can replace handwritten (and corruptible) logbooks and obviate the need to subpoena phone records from outside (non-integrated) providers as proof, etc.

The processor 304 may fetch, decode, and execute the machine-readable instructions 318 to create a new Blockchain or add a block to an existing Blockchain of previously created records, from the electronic record of the property maintenance complaint and/or notice. By creating a block within the Blockchain, the record is stored as an immutable and tamper-proof version of the record. Thus, Blockchain technology is leveraged to enhances the security of the system. Furthermore, the Defensive Property Management System 300 may communicate with a Blockchain network that includes the Blockchain and creates a unique Blockchain identifier that particularly corresponds to the new or added block on the Blockchain.

The processor 304 may fetch, decode, and execute the machine-readable instructions 320 to receive a request to retrieve a record of a property maintenance complaint and/or notice. For example, Defensive Property Management System 300 may receive the request from a user, such as a property owner, or an authorized agent of the property owner, such as an attorney. In some embodiments, the user requesting the record of the property maintenance complaint and/or notice is required to submit credentials.

The processor 304 may fetch, decode, and execute the machine-readable instructions 322 to verify the provided user credentials. For instance, in response to receiving the initial request submitted from a laptop computer, for example, the Defensive Property Management System 300 can transmit a query to the property owner for them to submit their credentials (e.g., username, password), and subsequently verifies the provided credentials prior to retrieving records. Accordingly, the records are only retrieved from the Defensive Property Management System 300 by authorized users.

The processor 304 may fetch, decode, and execute the machine-readable instructions 324 to retrieve the requested record of the property maintenance complaints and/or notices from the Blockchain. The Defensive Property Management System 300 accesses the Blockchain to retrieve the requested record. Also, the Defensive Property Management System 300 is able to identify one or more property maintenance complaints and/or notices that correspond to a particular tenant, and determine the corresponding block identifier for each complaint record that has been stored on the Blockchain for that tenant. The block identifiers can be used to access those specific blocks on the Blockchain.

The processor 304 may fetch, decode, and execute the machine-readable instructions 326 to transmit the retrieved record of the property maintenance complaints and/or notices from the Blockchain. In an embodiment, the Defensive Property Management System 300 transmits the retrieved record to a device of the requesting user. The Defensive Property Management System 300 can transmit a form including the contents of the record that was retrieved from the Blockchain to be displayed on user's device. Thus, by receiving the record from the Defensive Property Management System 300, for instance transmitting the record to a property owner's laptop computer, the record can be reviewed as a proof of the property owner's receipt (or proof of non-receipt) of notice of a particular maintenance problem.

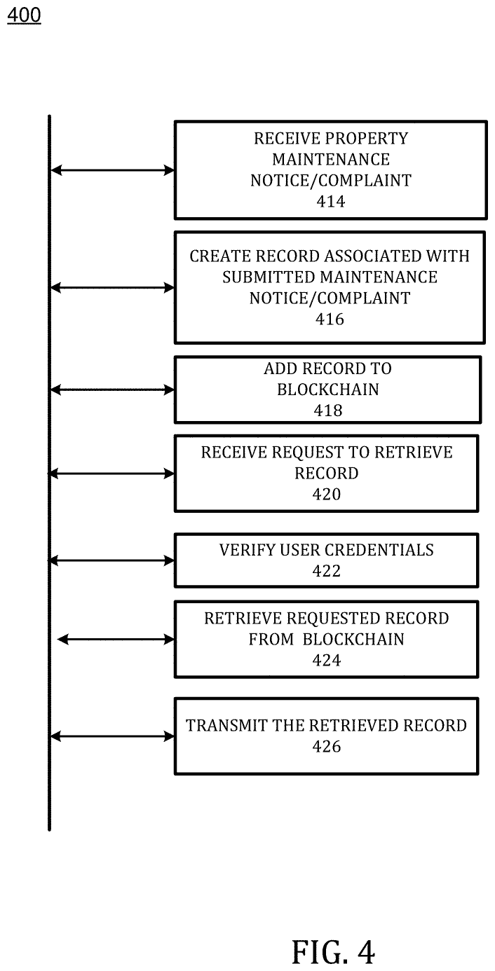

FIG. 4 illustrates a flow diagram 400 of an example method for implementing aspects of the Defensive Property Management System functionality, as disclosed herein. FIG. 4 illustrates a flow chart of an example method executed by the Defensive Property Management System (shown in FIG. 3). It should be understood that the method 400 depicted in FIG. 4 may include additional operations and that some of the operations described therein may be removed and/or modified without departing from the scope of the method 400. The description of the method 400 is also made with reference to the features depicted in FIG. 3 for purposes of illustration. Particularly, the processor 304 of the Defensive Property Management System 300 may execute some or all of the operations included in the method 400.

Referring to FIG. 4, the method 400 may also include one or more of the following steps. At block 414, the processor 304 may receive one or more property maintenance complaints and/or notices. At block 416, the processor 304 may create an electronic record of the property maintenance complaints and/or notices. At block 418, the processor 304 may create a new Blockchain and/or add a block to an existing Blockchain, where the block contains the electronic record of the property maintenance complaints and/or notices. At block 420, the processor 304 may receive a request to retrieve a record of the property maintenance complaints and/or notices from the Blockchain. At block 422, the processor 304 may verify the user's credentials in order to authorize access to the record of the property maintenance complaints and/or notices on the Blockchain. At block 424, the processor 304 may retrieve the requested record of the property maintenance complaints and/or notices from the Blockchain. At block 426, the processor 304 may transmit the retrieved record of the property maintenance complaints and/or notices to a user device for access and subsequent review.

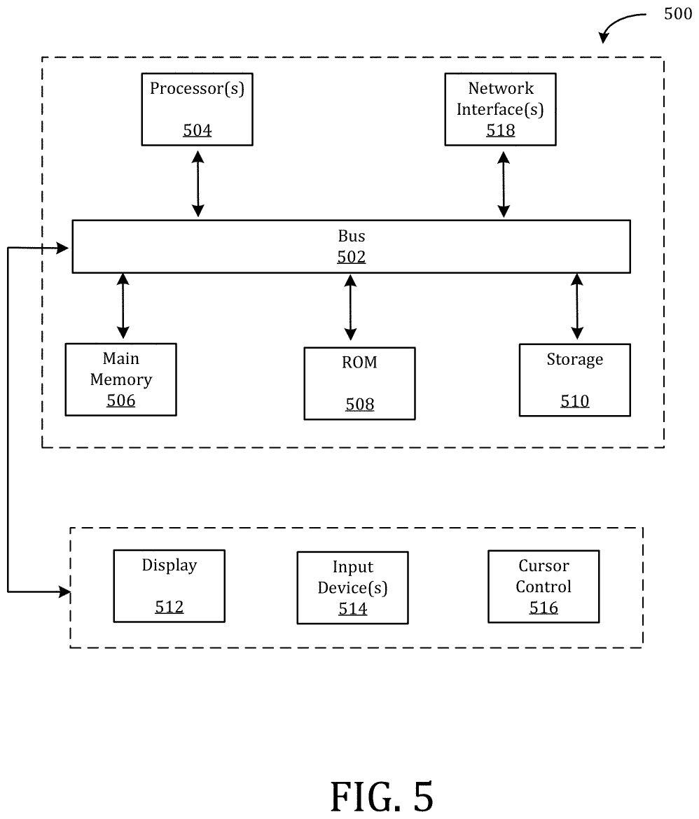

FIG. 5 depicts a block diagram of an example computer system 500 in which the disclosed aspects of the Defensive Property Management System (shown in FIG. 1) may be implemented. Furthermore, it should be appreciated that although the various instructions are illustrated as being co-located within a single processing unit, there may be some implementations in which processor(s) includes multiple processing units, allowing one or more instructions to be executed remotely from the other instructions.

The computer system 500 includes a bus 502 or other communication mechanism for communicating information, one or more hardware processors 504 coupled with a bus 512 for processing information. Hardware processor(s) 504 may be, for example, one or more general purpose microprocessors.

The computer system 500 also includes a main memory 506, such as a random-access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 300 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Python, Ruby on Rails or NodeJS. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which, in combination with the computer system, causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 318 may be a local area network (LAN) card to provide a data communication connection to a compatible LAN (or a WAN component that is configured to communicate with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through a local network to a host computer or to data equipment operated by an Internet Service Provider (ISP). The ISP in turn provides data communication services through the worldwide packet data communication network now commonly referred to as the “Internet.” Local networks and Internet both use electrical, electromagnetic, or optical signals that carry digital data streams. The signals through the various networks and the signals on network link and through communication interface 518, which carry the digital data to and from computer system 510, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

What is claimed is:

1. A system, comprising:
a centralized storage location; and
a server communicatively connected to the centralized storage location, the server comprising:
a processor;
a memory on which are stored machine-readable instructions that when executed by the processor, cause the processor to:
automate submission of one or more property maintenance complaints and notices;
create electronic records of the one or more property maintenance complaints and notices, wherein the electronic records are usable as proof of receipt for a property owner associated with a property that is admissible in a court of law;
storing the electronic records of the one or more property maintenance complaints and notices on the centralized storage location; and
retrieves the electronic records of the one or more property maintenance complaints and notices from the centralized storage location.

2. The system of claim 1, further comprising:
a plurality of devices associated with a property and communicatively connected to the server via a communication network.

3. The system of claim 2, wherein the plurality of devices comprises a computer device that submits the one or more property maintenance complaints and notices to the server as an automated form or an electronic message.

4. The system of claim 2, wherein the plurality of devices comprises a mobile telephone device that electronically submits the one or more property maintenance complaints and notices to the server via a mobile application.

5. The system of claim 2, wherein the plurality of devices comprises a telephone that submits the one or more property maintenance complaints and notices to the server via a telephone-based network connection via interactive voice response (IVR).

6. The system of claim 1, wherein the centralized storage location comprises a Blockchain.

7. The system of claim 6, wherein the electronic records of the one or more property maintenance complaints and notices are maintained on the Blockchain as immutable records of the property maintenance complaints and notices.

8. The system of claim 7, wherein blocks including the records of the one or more property maintenance complaints and notices are added to the Blockchain.

9. The system of claim 2, wherein the server generates automated forms to enter data for the one or more property maintenance complaints and notices using at least one of the plurality of devices.

10. The system of claim 1, further comprising:
a Personal Injury Prevention Projector (PIPP) communicatively connected to the server, wherein PIPP displays characters and images against a projection surface to be visible to persons proximate to an area such that the characters and images serve as a visible warning directly on the surface that is deemed hazardous.

11. The system of claim 10, wherein the PIPP transmits data representing time stamps and status identifiers to the server.

12. The system of claim 11, wherein the server creates an electronic record associated with the PIPP using the data transmitted from the PIPP.

13. A method, comprising:
receiving one or more property maintenance complaints and notices, wherein the one or more property maintenance complaint records are submitted from a submitter device associated with a property;
creating electronic records associated with the one or more property maintenance complaints and notices, wherein the electronic records are usable as proof of receipt for a property owner associated with the property that is admissible in a court of law; and
adding the electronic records associated with the one or more property maintenance complaints and notices to a Blockchain.

14. The method of claim 13, further comprising:
receiving a request to retrieve an electronic record associated with the one or more property maintenance complaints and notices from the Blockchain, wherein the request is submitted by a retriever device associated with the property;
verifying user credentials, wherein the user credential are associated with a requester device;
in response to successfully verifying the user credentials, retrieving the requested electronic record from the Blockchain; and
transmitting the retrieved electronic record to the requester device.

15. The method of claim 13, wherein adding the electronic records associated with the one or more property maintenance complaints and notices to a Blockchain comprises:
creating a block storing contents of the electronic record associated with the one or more property maintenance complaints and notices;
adding the block to the Blockchain;
communicating with a Blockchain network that includes the Blockchain; and
creating a block identifier that corresponds to the added block on the Blockchain.

16. The method of claim 14, wherein retrieving the requested electronic record from the Blockchain comprises:
determining a block identifier corresponding to the requested electronic record based on a tenant associated with the property; and
accessing the block on the Blockchain corresponding to the determined block identifier to retrieve contents of the requested electronic record stored in the block.

17. A non-transitory computer readable medium comprising instructions, that when read by a processor, cause the processor to perform:
receiving one or more property maintenance complaints and notices, wherein the one or more property maintenance complaint records are submitted from a submitter device associated with a property;
creating electronic records associated with the one or more property maintenance complaints and notices, wherein the electronic records are usable as proof of receipt for a property owner associated with the property that is admissible in a court of law; and
adding the electronic records associated with the one or more property maintenance complaints and notices to a Blockchain.

18. The non-transitory computer readable medium of claim 17, wherein the instructions, further cause the processor to perform:
receiving a request to retrieve an electronic record associated with the one or more property maintenance complaints and notices from the Blockchain, wherein the request is submitted by a retriever device associated with the property;
verifying user credentials, wherein the user credential are associated with a requester device;
in response to successfully verifying the user credentials, retrieving the requested electronic record from the Blockchain; and
transmitting the retrieved electronic record to the requester device.

19. The non-transitory computer readable medium of claim 18, wherein the instructions, further cause the processor to perform:
creating a block storing contents of the electronic record associated with the one or more property maintenance complaints and notices;
adding the block to the Blockchain;
communicating with a Blockchain network that includes the Blockchain; and
creating a block identifier that corresponds to the added block on the Blockchain.

20. The non-transitory computer readable medium of claim 19, wherein the instructions, further cause the processor to perform:
determining a block identifier corresponding to the requested electronic record based on a tenant associated with the property; and
accessing the block on the Blockchain corresponding to the determined block identifier to retrieve the contents of the electronic record stored in the block.
